(19) United States
(12) Patent Application Publication
(10) Pub. No.: US 2021/0313556 A1
(43) Pub. Date: Oct. 7, 2021

(54) ACTIVE MATERIAL, ACTIVE MATERIAL PRODUCTION METHOD, NONAQUEOUS ELECTROLYTE BATTERY, AND BATTERY PACK

(71) Applicant: KABUSHIKI KAISHA TOSHIBA, Tokyo (JP)

(72) Inventors: Hiroki INAGAKI, Yokohama-shi (JP); Norio Takami, Yokohama-shi (JP)

(73) Assignee: KABUSHIKI KAISHA TOSHIBA, Tokyo (JP)

(21) Appl. No.: 17/352,996

(22) Filed: Jun. 21, 2021

Related U.S. Application Data
(62) Division of application No. 13/722,292, filed on Dec. 20, 2012.

(30) Foreign Application Priority Data
Jan. 19, 2012 (JP) 2012-009235

(51) Int. Cl. H01M 4/131; C01G 23/00; H01M 4/485

(52) U.S. Cl. CPC H01M 4/131; C01G 23/005; H01M 4/485; H01M 10/0525; C01P 2004/62; C01P 2002/32; C01P 2002/72

(57) ABSTRACT

According to one embodiment, an active material includes a lithium-titanium composite oxide. The lithium-titanium composite oxide includes a lithium compound including at least one of lithium carbonate and lithium hydroxide. A lithium amount of the lithium compound is within a range of 0.017 to 0.073 mass %.

### CROSS-REFERENCE TO RELATED APPLICATIONS

This application is based upon and claims the benefit of priority from Japanese Patent Application No. 2012-009235, filed Jan. 19, 2012, the entire contents of which are incorporated herein by reference.

### FIELD

Embodiments described herein relate to an active material, a method for producing the active material, a nonaqueous electrolyte battery, and a battery pack.

### BACKGROUND

Research-and-development of a nonaqueous electrolyte battery in which charge-discharge is attained by migration of lithium ions between a negative electrode and a positive electrode has been in active progress. The nonaqueous electrolyte battery is required to have various properties depending on the usages. For example, it is estimated that about 3C discharge is required for a power source for a digital camera, and about 10C discharge or more is required for an in-vehicle use such as a hybrid electric vehicle or the like. Therefore, the nonaqueous electrolyte battery for these usages is required to have excellent charge-discharge cycle life in the case where charge-discharge is repeated at a large current.

A nonaqueous electrolyte battery in which lithium-transition metal composite oxide is used as a positive electrode active material and a carbonaceous material as a negative electrode active material is commercialized at present. As a transition metal in the lithium-transition metal composite oxide, Co, Mn, Ni, or the like is used.

Recently, a nonaqueous electrolyte battery using, as the negative electrode, lithium-titanium composite oxide having high Li absorption-release potential as compared to the carbonaceous material has been put into practical use. Since a volume change caused by charge-discharge is suppressed in the lithium-titanium oxide, the lithium-titanium oxide is excellent in cycle performance as compared to the carbonaceous material. Among others, spinel type lithium titanate is promising.

Since a volume change in charge-discharge is suppressed in the spinel type lithium titanate, the spinel type lithium titanate when used as the negative electrode active material can realize a nonaqueous electrolyte battery which is suppressed in volume change and is less subject to short-circuiting and a capacity loss which can be caused by electrode swelling. However, there is a demand for improvement in battery resistance of the nonaqueous electrolyte battery using the lithium titanate as the negative electrode active material.

### BRIEF DESCRIPTION OF THE DRAWINGS

FIG. 1 is a schematic diagram showing a surface of titanium oxide;

FIG. 2 is a schematic diagram showing a surface of the titanium oxide to which hydroxide groups are bonded;

FIG. 3 is a sectional view schematically showing a nonaqueous electrolyte battery according to a second embodiment;

FIG. 4 is an enlarged sectional view schematically showing a part enclosed by a circle indicated by “A” in FIG. 3;

FIG. 5 is an a partially broken perspective view schematically showing the nonaqueous electrolyte battery according to the second embodiment;

FIG. 6 is an enlarged sectional view showing a part-B of FIG. 5;

FIG. 7 is an exploded perspective view showing a battery pack according to a third embodiment; and

FIG. 8 is a block diagram showing an electric circuit of the battery pack of FIG. 7.

### DETAILED DESCRIPTION

According to one embodiment, there is provided an active material including lithium-titanium composite oxide. The lithium-titanium composite oxide includes a lithium compound including at least one of lithium carbonate and lithium hydroxide. A lithium amount of the lithium compound is 0.017 mass % or more and 0.073 mass % or less.

According to another one embodiment, there is provided a nonaqueous electrolyte battery including a positive electrode, a negative electrode including the active material according to the above-described embodiment, and a nonaqueous electrolyte.

According to yet another one embodiment, there is provided a battery pack including the nonaqueous electrolyte battery including the active material according to the above-described embodiment.

Hereinafter, the embodiments are described with reference to the drawings. Structures common throughout the embodiments are denoted by an identical reference numeral, and an overlapping description thereof is not repeated. Further, the drawings are schematic diagrams which are for the purposes of illustration and promoting understanding of the embodiments, and, though some of shapes, dimensions, ratios, and the like of the drawings are different from those of the actual devices, the shapes, dimensions, ratios, and the like can appropriately be designed and changed by taking the following description and the well-known art into consideration.

### First Embodiment

According to the first embodiment, there is provided an active material containing lithium-titanium composite oxide. The lithium-titanium composite oxide contains a lithium compound formed of at least one of lithium carbonate and lithium hydroxide. A lithium amount of the lithium compound is 0.017 mass % or more and 0.073 mass % or less.

As a result of an extensive research, the inventors detected the factor for an increase in resistance of a nonaqueous electrolyte battery.

FIG. 1 is a schematic diagram showing an enlarged crystal structure of a particle surface of the lithium-titanium composite oxide. On the particle surface (crystal surface) 41 of the lithium-titanium composite oxide, a regular bonding between atoms is disconnected. The state in which the bonding between atoms is disconnected is indicated by a dotted line in FIG. 1.

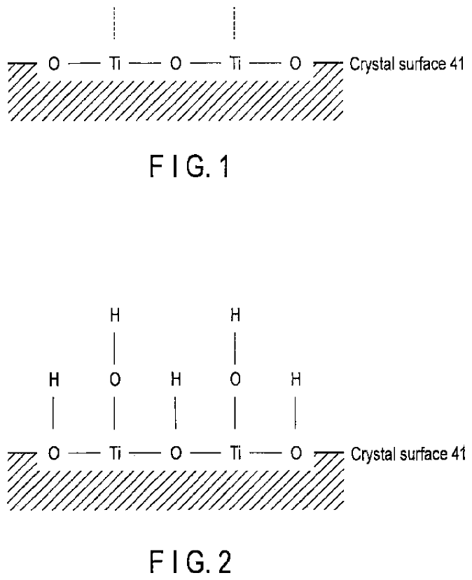

The atoms on the particle surface 41 are unstable compared to atoms inside the particle, and Ti⁴⁺ ions on the particle surface 41 are in an unsaturated state. The unsaturated bonds are chemically bonded with moisture in the air to be hydroxide groups, and, as a result, a crystal structure shown in FIG. 2 is formed.

On the other hand, of lithium in the lithium-titanium composite oxide, a non-reacted lithium component which slightly remains after calcination exists as lithium carbonate and lithium hydroxide. The lithium hydroxide reacts with carbon dioxide in the air to change into lithium carbonate. Therefore, the lithium-titanium composite oxide contains lithium carbonate, lithium hydroxide, or both of lithium carbonate and lithium hydroxide.

In the case of using the lithium-titanium composite oxide particles as the active material, the moisture and the hydroxide groups which are adsorbed to the surface of the lithium-titanium composite oxide particles react with a lithium salt (LiPF₆ or the like) in an electrolyte solution to generate a free acid (hydrofluoric acid). An amount of the free acid is larger than the case of using the carbonaceous material as the active material, and, as a result, the hydrolysis of the lithium carbonate occurs, specifically, the free acid reacts with the lithium carbonate remaining in the lithium-titanium composite oxide to generate carbon dioxide. The inventors found that the carbon dioxide induces swelling of the electrode to cause deterioration of battery properties. The inventors found out that the generated gas tends to remain between the electrodes in the case of producing a large battery for use in vehicles and the like and considerably deteriorates the battery properties, especially the rate performance and the output performance.

The inventors found that, in the lithium-titanium composite oxide containing the lithium compound formed of at least one of lithium carbonate and lithium hydroxide, it is possible to suppress the electrode swelling by reducing the amount of the generated gas by having a lithium amount of the lithium compound of 0.073 mass % or less. While a smaller amount of lithium is advantageous for the suppression of electrode swelling, a battery resistance is increased, when the lithium amount is less than 0.017 mass %, thereby to deteriorate a rate performance and an output performance of the battery. The reason for the deteriorations is as follows. It is necessary to reduce an amount of the lithium compound in order to reduce the lithium amount. In order to reduce the lithium compound so as to attain the lithium amount of less than 0.017 mass %, it is necessary to subject the lithium-titanium composite oxide to an acid treatment, and crystallinity of the lithium-titanium composite oxide is deteriorated by the acid treatment. As a result, the battery resistance is increased to cause the deteriorations in battery discharge capacity, rate performance, and output performance. Therefore, the lithium amount of the lithium compound may preferably be 0.017 mass % or more and 0.073 mass % or less. It is possible to further suppress the electrode swelling by having the lithium amount of the lithium compound of from 0.017 mass % to 0.053 mass %.

The lithium amount (X, Y) of the lithium compound is calculated by the following expression (I):

Lithium amount(X,Y)=N×(M1/M2) (I).

In the expression (I), N represents the lithium compound content (mass %) of the lithium-titanium composite oxide; M1 represents a Li mass per one mole of the lithium compound; and M2 represents a mass of one mole of the lithium compound.

As one example, a case in which an amount of lithium carbonate (Li₂CO₃) contained in lithium-titanium composite oxide is 1.00 mass % will be described. Since atomic weights of Li, C, and O are 6.939, 12.01115, and 15.9994, a molecular weight M2 of lithium carbonate is 73.88735. A Li mass M1 per one mole of the lithium carbonate is calculated from 6.939×2 and is 13.878. A lithium amount X (mass %) contained in the lithium carbonate is calculated from 1.00×(6.939×2)/73.88735 in accordance with the expression (I), and X=0.188 mass % is obtained. A molecular weight M2 of lithium hydroxide (LiOH) is 23.94637 since atomic weights of Li, H, and O are 6.939, 1.00797, and 15.9994. In the case where an amount N of the lithium hydroxide contained in the lithium-titanium composite oxide is 1.00 mass %, an amount Y (mass %) of the lithium contained in the lithium hydroxide is calculated from 1.00×6.939/23.94637 in accordance with the expression (I), and Y=0.290 mass % holds.

In the case where both of lithium carbonate and lithium hydroxide are contained in lithium-titanium composite oxide, a sum of X and Y is the lithium amount to be detected. Further, X is the lithium amount to be detected in the case where only lithium carbonate is contained in lithium-titanium composite oxide, and Y is the lithium amount to be detected in the case where only lithium hydroxide is contained in lithium-titanium composite oxide.

The lithium-titanium composite oxide may desirably contain either one of a lithium titanium oxide phase or a lithium titanium-containing oxide phase. The lithium titanium-containing oxide is an oxide satisfying that a part of constituent elements of lithium titanium oxide is substituted with a different element. In order to attain excellent large current performance and cycle performance, the lithium-titanium composite oxide may preferably contain the lithium titanium oxide phase as a main phase. The main phase means a phase with the highest abundance ratio in the lithium-titanium composite oxide.

It is possible to confirm the abundance ratio of phase by the method described below.

From an X-ray diffraction pattern detected by an X-ray diffraction measurement of lithium-titanium composite oxide particles, phases of the lithium-titanium composite oxide are identified. It is possible to specify the main phase of the lithium-titanium composite oxide by comparing intensity ratios of main peaks of the identified constituent phases.

For instance, in the case of spinel type lithium-titanium composite oxide [Li₄₊ₓTi₅O₁₂ (X satisfies 0≤x≤3)], anatase type TiO₂, rutile type TiO₂, Li₂TiO₃, or the like are in some cases contained as impurity phases. When an X-ray diffraction measurement of such substance is performed using Cu-Kα, it is confirmed from the X-ray diffraction pattern that a main peak of Li₄₊ₓTi₅O₁₂ (X satisfies 0≤x≤3) appears on 4.83 Å (2θ: 18°), and main peaks of anatase type TiO₂, rutile type TiO₂, and Li₂TiO₃ appear on 3.51 Å (2θ: 25°), 3.25 Å (2θ: 27°), and 2.07 Å (2θ: 43°). The main phase is specified by comparing intensities of the main peaks.

In the case where spinel type lithium-titanium composite oxide is the main phase, each of main peak intensities of anatase type TiO₂, rutile type TiO₂, and Li₂TiO₃ may preferably be 7 or less, more preferably 3 or less, when a main peak intensity of the spinel lithium titanate detected by the X-ray diffractometry is 100. This is because, with smaller ratio of the impurity phases, a diffusion rate of the lithium ions is improved, and moreover, ion conductivity and large current performance are enhanced.

Examples of the lithium titanium oxide include lithium titanium oxide having a spinel structure [e.g. Li₄₊ₓTi₅O₁₂ (x satisfies 0≤x≤3), ramsdellite type lithium titanium oxide [e.g. Li_{2+y}Ti₃O₇ (y satisfies 0≤y≤3)], and the like. The lithium titanium oxide having spinel structure is preferred since it enables to attain the excellent charge-discharge cycle performance.

It is acceptable when the lithium-titanium composite oxide contains a phase other than the lithium titanium oxide phase and the lithium titanium-containing oxide phase. For example, a TiO₂ phase, Li₂TiO₃ phase, or the like may be contained.

The lithium-titanium composite oxide may be in the form of primary particles each of which exists as a single particle, secondary particle resulted from aggregation of the primary particles, or a mixture thereof. An average particle diameter of the lithium-titanium composite oxide may be 10 nm or more and 10 μm or less. The average particle diameter may be measured by laser diffractometry. Further, a specific surface area of the lithium-titanium composite oxide detected by a BET method through N₂ adsorption may be 3 m²/g or more and 50 m²/g or less.

A method for producing the lithium-titanium composite oxide will hereinafter be described. A lithium-titanium composite oxide synthesis method includes a step of synthesizing lithium-titanium composite oxide by calcining a material containing a lithium salt and titanium oxide and a step of washing the lithium-titanium composite oxide with water containing carbon dioxide.

The lithium-titanium composite oxide synthesis step will be described first. Lithium salts such as lithium hydroxide, lithium oxide, and lithium carbonate are used as Li sources. Predetermined amounts of the Li sources are dissolved in pure water. To the obtained solution, titanium oxide is added so that an atomic ratio between lithium and titanium becomes a predetermined ratio. For example, in the case of synthesizing spinel type lithium titanium oxide having the composition formula Li₄Ti₅O₁₂, the mixing is performed in such a manner that a Li:Ti atomic ratio becomes 4:5. Further, in the case of synthesizing ramsdellite type lithium titanium oxide having the composition formula Li₂Ti₃O₇, the mixing is performed in such a manner that a Li:Ti atomic ratio becomes 2:3.

Subsequently, the obtained solution is dried with stirring to obtain a precursor before calcination. Examples of the drying include spray drying, granulation drying, freeze drying, or combinations thereof. The obtained precursor before calcination is then calcined to obtain the lithium-titanium composite oxide. The calcination may sufficiently be performed in the air or may be performed under an oxygen atmosphere or an inert atmosphere using argon or the like.

In the case of synthesizing the spinel type, the calcination may be performed at 680° C. or more and 1000° C. or less for one hour or more and 24 hours or less, preferably 720° C. or more and 800° C. or less for 5 hours or more and 10 hours or less.

When the temperature is less than 680° C., a reaction between the titanium oxide and the lithium compound becomes insufficient, causing impurity phases of the anatase type TiO₂, rutile type TiO₂, Li₂TiO₃, and the like to be increased, thereby reducing an electric capacity. When the temperature exceeds 1000° C., a crystallite diameter of the spinal type lithium titanate excessively grows due to progress of calcination allowing deterioration of the large current performance.

In the case of synthesizing the ramsdellite type, the calcination may be performed at 900° C. or more and 1300° C. or less for one hour or more and 24 hours or less, preferably 940° C. or more and 1100° C. or less for one hour or more and 10 hours or less.

The lithium-titanium composite oxide particles obtained by the synthesis step are pulverized into particles having a desired particle diameter under the conditions described below. As a pulverization method, a mortar, a ball mill, a sand mill, a vibration ball mill, a planetary ball mill, a jet mill, a counter jet mill, a swirling airflow jet mill, a sieve, or the like may be used. In the pulverization, a wet pulverization in which a known liquid pulverization aid such as water, ethanol, ethylene glycol, benzene, or hexane is used may be employed. The pulverization aid is effective for improving pulverization efficiency and increasing a fine particles yield. A more preferred method is the ball milling using zirconia balls as a medium, and the method is suitable for the wet pulverization using the liquid pulverization aid.

Further, an organic substance such as polyol which improves pulverization efficiency may be added as a pulverization aid. The type of the polyol is not particularly limited, and pentaerythritol, triethylolethane, trimethylolpropane, and the like may be used alone or in combination.

Next, the washing treatment step is performed. The obtained lithium-titanium composite oxide particles are impregnated into water to obtain a slurry. Carbon dioxide is introduced into the obtained slurry, followed by stirring, whereby a reaction of a chemical formula (1) shown as [Chemical formula 1] occurs in the slurry. After that, the slurry is separated into a powder and water by filtering or the like.

[Chemical formula 1]

Li₂CO₃+CO₂+H₂O→2LiHCO₃ (1)

As described above, by the step of performing the treatment of washing the lithium-titanium composite oxide with the water containing carbon dioxide, the lithium carbonate present in the lithium-titanium composite oxide is changed into the lithium hydrogen carbonate and is dissolved into water, according to the reaction of the chemical formula (1). A solubility of lithium carbonate into water is low and only 1.33 g of lithium carbonate is dissolved respective to 100 mL of water at 25° C. In contrast, a solubility of the lithium hydrogen carbonate is about 10 times that of lithium carbonate. Therefore, it is possible to efficiently remove lithium carbonate with a small amount of water in a short length of time by changing the lithium carbonate into lithium hydrogen carbonate. By incorporating the step, the lithium-titanium composite oxide with small amounts of lithium carbonate and lithium hydroxide is obtained.

The introduction of carbon dioxide into the slurry is attained by blowing the carbon dioxide into the sully or by increasing a partial pressure of the carbon dioxide under a slurry storage atmosphere to be higher than the air. In the case of more aggressively introducing carbon dioxide, an amount carbon dioxide to be introduced may be one or more by molar ratio relative to lithium carbonate remaining in the lithium-titanium composite oxide. A more preferred range is one or more and 5 or less. The lithium carbonate remaining in the lithium-titanium composite oxide is detected by measuring a lithium carbonate amount in the lithium-titanium composite oxide before the washing treatment. An endpoint of the process of introducing carbon dioxide into the slurry is efficiently decided by controlling a feed rate of carbon dioxide to a calculation amount of carbon dioxide based on a predetermined lithium concentration. The control is recommended because a solubilization reaction of lithium carbonate by the carbon dioxide introduction, i.e. the lithium hydrogen carbonate generation reaction, is the equilibrium reaction as indicated by the formula (1), and because a change in consumption amount of lithium carbonate is smaller than a change in carbon dioxide introduction amount.

An ambient temperature in the washing treatment may be −40° C. or more and 50° C. or less. By setting the ambient temperature to 0° C. or more and 30° C. or less, it is possible to retain carbon dioxide in the slurry at a high concentration and to avoid decomposition of the lithium hydrogen carbonate. Since the washing treatment is performed rapidly by a contact between lithium carbonate and carbon dioxide, a reaction time is not particularly limited.

In the washing treatment, the carbon dioxide and the lithium carbonate may preferably be subjected to be dispersed and contact in an efficient gas-liquid contact equipment such as a high speed stirrer since high lithium hydrogen carbonate generation efficiency is attained by the improvement in contact efficiency between the carbon dioxide and the lithium carbonate. The washing treatment may be performed under an ordinary pressure or an increased pressure.

After the washing treatment step, a powder containing the lithium-titanium composite oxide which is an insoluble component is extracted by filtering. By subjecting the filtered power to drying or re-calcination, the lithium-titanium composite oxide reduced in lithium carbonate and lithium hydroxide is obtained.

The re-calcination may sufficiently be performed in the air or may be performed under an oxygen atmosphere or an inert atmosphere using argon or the like. The re-calcination may be performed at 250° C. or more and 900° C. or less for about one minute or more and 10 hours or less. After the washing treatment, there is deposited lithium carbonate or lithium hydroxide which is not removed by the washing treatment or re-adhered after the washing treatment remains in the powder after the filtering. As a result of newly generating a lithium titanium oxide phase from the lithium carbonate and lithium hydroxide by the re-calcination, the lithium carbonate amount and the lithium hydroxide amount in the lithium-titanium composite oxide are further reduced. The re-calcination may preferably be performed at 400° C. or more and 700° C. or less for 10 minutes or more and 3 hours or less.

The above-described lithium-titanium composite oxide production method is particularly effective for removing lithium carbonate from lithium-titanium composite oxide having large specific surface area. In a nonaqueous electrolyte battery using the lithium-titanium composite oxide as the active material, the gas generation is suppressed so that the excellent rate performance and output performance can be attained.

Since the lithium-titanium composite oxide of the first embodiment contains the lithium compound formed of at least one of lithium carbonate and lithium hydroxide, and since the lithium amount of the lithium compound is 0.017 mass % or more and 0.073 mass % or less, the amount of generated gas is reduced, and the electrode swelling is suppressed. Further, the battery resistance is reduced.

### Second Embodiment

According to the second embodiment, a nonaqueous electrolyte battery including a positive electrode, a negative electrode, and a nonaqueous electrolyte is provided. The negative electrode contains the active material of the first embodiment. Hereinafter, the positive electrode, the negative electrode, and the nonaqueous electrolyte will be described.

### 1) Positive Electrode

The positive electrode comprises a positive electrode current collector and a positive electrode active material-containing layer which is supported on one surface or both surfaces of the positive electrode current collector and contains a positive electrode active material, a positive electrode conductive agent, and a binder.

Examples of the positive electrode active material include an oxide, a sulfide, a polymer, and the like. The number of kinds of the positive electrode active material may be one or two or more.

For example, as the oxide, manganese dioxide (MnO₂) capable of absorbing Li, iron oxide, copper oxide, nickel oxide, lithium-manganese composite oxide (e.g. LiₓMn₂O₄ or LiₓMnO₂), lithium-nickel composite oxide (e.g. LiₓNiO₂), lithium-cobalt composite oxide (e.g. LiₓCoO₂), lithium-nickel-cobalt composite oxide (e.g. LiNi_{1-y}Co_{y}O₂), lithium-manganese-cobalt composite oxide (e.g. LiₓMn_{y}Co_{1-y}O₂), spinel type lithium-manganese-nickel composite oxide (e.g. LiₓMn_{2-y}Ni_{y}O₄), lithium-phosphorus oxide having olivine structure (e.g. LiₓFePO₄, LiₓFe_{1-y}Mn_{y}PO₄, LiₓCoPO₄), iron sulfate (e.g. Fe₂(SO₄)₃), or vanadium oxide (e.g. V₂O₅) may be used. Here, x and y may preferably satisfy 0<x≤1 and 0≤y≤1.

As the polymer, a conductive polymer material such as polyaniline and polypyrrole or a disulfide-based polymer material may be used. Further, sulfur (S) or carbon fluoride may be used as the active material.

Preferred examples of the active material include those which attain a high positive electrode potential, such as lithium-manganese composite oxide (e.g. LiₓMn₂O₄), lithium-nickel composite oxide (e.g. LiₓNiO₂), lithium-cobalt composite oxide (e.g. LiₓCoO₂), lithium-nickel-cobalt composite oxide (e.g. LiₓNi_{1-y}Co_{y}O₂), spinel type lithium-manganese-nickel composite oxide (e.g. LiₓMn_{2-y}Ni_{y}O₄), lithium-manganese-cobalt composite oxide (e.g. LiₓMn_{y}Co_{1-y}O₂), lithium iron phosphate (e.g. LiₓFePO₄), lithium-nickel-cobalt-manganese composite oxide, and the like. Here, x and y may preferably satisfy 0<x≤1 and 0≤y≤1.

A composition of the lithium-nickel-cobalt-manganese composite oxide may preferably be LiₐNi_{b}Co_{c}Mn_{d}O₂ (provided that molar ratios a, b, c, and d satisfy 0≤a≤1.1, 0.1≤b≤0.5, 0≤c≤0.9, 0.1≤d≤0.5).

In the case of using a nonaqueous electrolyte containing an ionic liquid, it is preferable to use lithium iron phosphate, LiₓVPO₄F, lithium-manganese composite oxide, lithium-nickel composite oxide, or lithium-nickel-cobalt composite oxide from the viewpoint of cycle life. These oxides are preferred because they suppress reactivity between the positive electrode active material and the ionic liquid.

Further, examples of a positive electrode material for a primary battery include manganese dioxide, iron oxide, copper oxide, iron sulfide, carbon fluoride, and the like.

A primary particle diameter of the positive electrode active material may preferably be 100 nm or more and 1 μm or less. Handling easiness in industrial production is attained when the primary particle diameter is 100 nm or more. Diffusing of lithium ions in a solid can be promoted smoothly when the primary particle diameter is 1 μm or less.

A specific surface area of the positive electrode active material may preferably be 0.1 m²/g or more and 10 m²/g or less. When the specific surface area is 0.1 m²/g or more, absorption-release sites for lithium ions can be ensured sufficiently. When the specific surface area is 10 m²/g or less, handling easiness in industrial production is attained, and a favorable charge-discharge cycle performance is ensured.

Examples of the positive electrode conductive agent for improving current collection and suppressing a contact resistance with the current collector include a carbonaceous material such as acetylene black, carbon black, graphite, and the like.

Examples of the binder for binding the positive electrode active material and the positive electrode conductive agent to each other include polytetrafluoroethylene (PTFE), polyvinylidene fluoride (PVdF), a fluorine-based rubber, and the like.

A mixing ratio of the positive electrode active material, the positive electrode conductive agent, and the binder may preferably be such that the positive electrode active material is within the range of 80 mass % or more and 95 mass % or less; the positive electrode conductive agent is within the range of 3 mass % or more and 18 mass % or less; and the binder is within the range of 2 mass % or more and 17 mass % or less. The positive electrode conductive agent exhibits the above-described effects when the ratio is 3 mass % or more and suppresses decomposition of the nonaqueous electrolyte on the positive electrode conductive agent surface under high temperature storage when the ratio is 18 mass % or less. The binder enables to attain satisfactory electrode strength when the ratio is 2 mass % or more and reduces a mixing amount of an insulator of the electrode to suppress an internal resistance when the ratio is 17 mass % or less.

The positive electrode is produced by suspending the positive electrode active material, the positive electrode conductive agent, and the binder into an appropriate solvent to obtain a slurry, forming the positive electrode active material-containing layer by coating the slurry on the positive electrode current collector, drying, and pressing. Alternatively, the positive electrode active material, the positive electrode conductive agent, and the binder may be formed into pellets to be used for the positive electrode active material-containing layer.

An aluminum foil or an aluminum alloy foil may preferably be used for the positive electrode current collector, and an average crystal grain size may preferably be 50 μm or less as is the case with a negative electrode current collector. The average crystal grain size may more preferably be 30 μm or less, further preferably 5 μm or less. The average crystal grain size of 50 μm or less enables to drastically increase the strength of the aluminum foil or aluminum alloy foil, making it possible to densify the positive electrode at a high pressing pressure, resulting in increased battery capacity.

An aluminum foil or an aluminum alloy foil having an average crystal grain size in the range of 50 μm or less is affected by many factors such as compositions of materials, impurities, process conditions, heat treatment history and heating conditions for annealing, and a crystal grain size (diameter) is adjusted by combining various factors in production steps.

A thickness of the aluminum foil or aluminum alloy foil may preferably be 20 μm or less, more preferably 15 μm or less. A purity of the aluminum foil may preferably be 99 mass % or more. As the aluminum alloy, an alloy containing an element such as magnesium, zinc, and silicon is preferred. On the other hand, a content of a transition metal such as iron, copper, nickel, and chrome may preferably be 1 mass % or less.

### 2) Negative Electrode

The negative electrode includes a negative electrode current collector and a negative electrode active material-containing layer which is supported on one surface or both surfaces of the negative electrode current collector and contains a negative electrode active material, a negative electrode conductive agent, and a binder.

As the negative electrode active material, the active material of the first embodiment is used.

The negative electrode current collector may preferably be an aluminum foil or an aluminum alloy foil. With such negative electrode current collector, melting and corrosion thereof at an overdischarge cycle is prevented.

A thickness of the aluminum foil or the aluminum alloy foil may preferably be 20 μm or less, more preferably 15 μm or less. A purity of the aluminum foil may preferably be 99 mass % or more. As the aluminum alloy, an alloy containing an element such as magnesium, zinc, and silicon is preferred. On the other hand, a content of a transition metal such as iron, copper, nickel, and chrome may preferably be 1 mass % or less.

The conductive agent may be contained in the negative electrode active material-containing layer.

As the conductive agent, a carbon material, a metal powder such as an aluminum powder, or a conductive ceramic such as TiO may be used. Examples of the carbon material include acetylene black, carbon black, cokes, a carbon fiber, and graphite. More preferably, cokes which is subjected to a heat treatment at 800° C. to 2000° C. and has an average particle diameter of 10 μm or less, graphite, a TiO powder, or a carbon fiber having an average particle diameter of 1 μm or less may be used. A specific surface area of the carbon material detected by a BET method through N₂ absorption may preferably be 10 m²/g or more.

The binder may be contained in the negative electrode active material-containing layer. Examples of the binder include polytetrafluoroethylene (PTFE), polyvinylidene fluoride (PVdF), a fluorine-based rubber, a styrene butadiene rubber, a core-shell binder, and the like.

A mixing ratio of the negative electrode active material, the negative electrode conductive agent, and the binder may preferably be such that the negative electrode active material is within the range of 70 mass % or more and 96 mass % or less; the negative electrode conductive agent is within the range of 2 mass % or more and 28 mass % or less; and the binder is within the range of 2 mass % or more and 28 mass % or less. When the negative electrode conductive agent amount is less than 2 mass %, a current collection of the negative electrode active material-containing layer may be reduced to reduce the large current performance of the nonaqueous electrolyte battery. Further, when the binder amount is less than 2 mass %, the binding between the negative electrode active material-containing layer and the negative electrode current collector may be deteriorated to reduce the cycle performance. On the other hand, the amount of each of the negative electrode conductive agent and the binder may preferably be 28 mass % or less from the viewpoint of high capacity.

The negative electrode is produced by suspending the negative electrode active material, the negative electrode conductive agent, and the binder into a generally-used solvent to obtain a slurry, forming the negative electrode active material-containing layer by coating the slurry on the negative electrode current collector, drying, and pressing.

### 3) Nonaqueous Electrolyte

Examples of the nonaqueous electrolyte include a liquid nonaqueous electrolyte prepared by dissolving an electrolyte into an organic solvent and a gel nonaqueous electrolyte obtained by compositing a liquid electrolyte and a polymer material.

As the nonaqueous electrolyte, those which are not volatile and contain a room temperature molten salt formed of a flame-resistant ionic liquid may be used.

The liquid nonaqueous electrolyte is prepared by dissolving an electrolyte at a concentration of 0.5 mol/L or more and 2.5 mol/L or less into an organic solvent.

Examples of the electrolyte include a lithium salt such as lithium perchlorate (LiClO₄), lithium hexafluorophosphate (LiPF₆), lithium tetrafluoroborate (LiBF₄), lithium arsenic hexafluoride (LiAsF₆), lithium trifluoromethanesulfonate (LiCF₃SO₃), bistrifluoromethylsulfonylimide lithium [LiN(CF₃SO₂)₂], and the like. The number of kinds of the electrolyte may be one or two or more. The electrolyte containing LiBF₄ is preferred since it is capable of further enhancing nonaqueous electrolyte impregnation property of the negative electrode active material.

Examples of the organic solvent include a cyclic carbonate such as propylene carbonate (PC), ethylene carbonate (EC), and a vinylene carbonate; a chain carbonate such as diethyl carbonate (DEC), dimethyl carbonate (DMC), and methylethyl carbonate (MEC); a cyclic ether such as tetrahydrofuran (THF), 2-methyltetrahydrofuran (2MeTHF), and dioxolan (DOX); a chain ether such as dimethoxyethane (DME) and diethoxyethane (DEE); γ-butyrolactone (GBL); acetonitrile (AN); sulfolane (SL); and the like, which are used alone or as a mixture solvent containing two or more thereof.

Examples of the polymer material include polyvinylidene fluoride (PVdF), polyacrylonitrile (PAN), polyethylene oxide (PEO), and the like.

Hereinafter, the nonaqueous electrolyte containing the room temperature molten salt will be described.

The room temperature molten salt means a salt of which at least a part turns into a liquid at a room temperature, and the room temperature means a temperature range within which a power source is ordinarily expected to operate. An upper limit of the temperature range within which a power source is ordinarily expected to operate is about 120° C. or 60° C. in some cases, and a lower limit thereof is about −40° C. or −20° C. in some cases. Among the above, the range of −20° C. or more and 60° C. or less is suitable.

As the room temperature molten salt containing lithium ion, an ionic melt formed of the lithium ion, an organic cation, and an anion may probably be used. The ionic melt may preferably be in the form of a liquid at a room temperature or a temperature lower than the room temperature.

Examples of the organic cation include an alkylimidazolium ion having the skeleton shown under Chemical formula 2, and a quaternary ammonium ion.

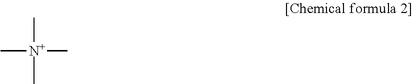

As the alkylimidazolium ion, a dialkylimidazolium ion, a trialkylimidazolium ion, a tetraalkylimidazolium ion, or the like are preferred. As the dialkylimidazolium, a 1-methyl-3-ethylimidazolium ion (MEI⁺) is preferred. As the trialkylimidazolium ion, a 1,2-diethyl-3-propylimidazolium ion (DMPI⁺) is preferred. As the tetraalkylimidazolium ion, 1,2-diethyl-3,4(5)-dimethylimidazolium ion is preferred.

As the quaternary ammonium ion, a tetraalkylammonium ion, a cyclic ammonium ion, or the like are preferred. Examples of the tetraalkylammonium ion include a dimethylethylmethoxyammonium ion, a dimethylethylmethoxymethylammonium ion, a dimethylethylethoxyethylammonium ion, and a trimethylpropylammonium ion are preferred.

With the use of the alkylimidazolium ion or the quaternary ammonium ion (particularly, tetraalkylammonium ion), a melting point is maintained to 100° C. or less, more preferably 20° C. or less. Further, reactivity with the negative electrode can be suppressed.

A concentration of lithium ions may preferably be 20 mol % or less. A more preferred range is 1 to 10 mol %. By maintaining the above-specified ranges, a room temperature molten salt in the form of a liquid is readily formed at a low temperature such as 20° C. or less. Further, since it is possible to reduce a viscosity at a temperature equal to or lower than the room temperature, it is possible to improve ion conductivity.

The anion may preferably be at least one anion selected from BF₄⁻, PF₆⁻, AsF₆⁻, ClO₄⁻, CF₃SO₃⁻, CF₃COO⁻CH₃COO⁻, CO₃²⁻, N(CF₃SO₂)₂⁻, N(C₂F₅SO₂)₂⁻, (CF₃SO₂)₃C⁻, and the like. The room temperature molten salt having a melting point of 20° C. or less is readily formed by using a plurality of anions in combination. More preferably, the room temperature molten salt may have a melting point of 0° C. or less. More preferred examples of the anion include BF₄⁻, CF₃SO₃⁻, CF₃COO⁻CH₃COO⁻, CO₃²⁻, N(CF₃SO₂)₂⁻, N(C₂F₅SO₂)₂⁻, and (CF₃SO₂)₃C⁻. With the use of these anions, formation of a room temperature molten salt having a melting point of 0° C. or less is facilitated.

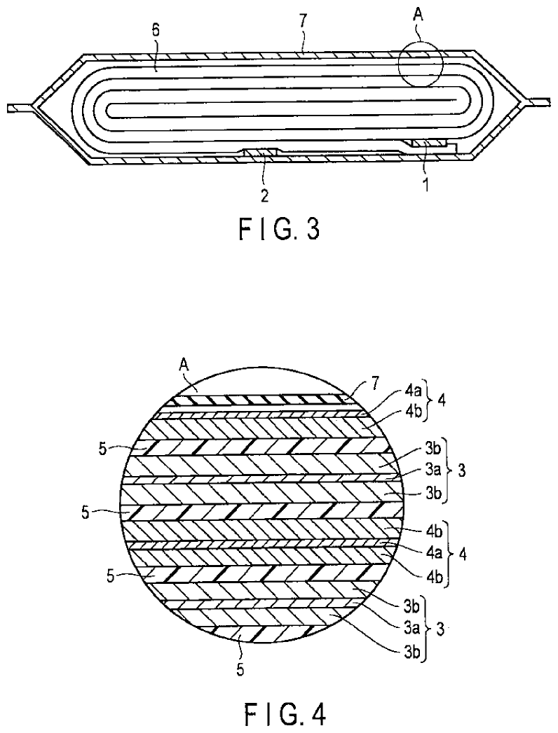

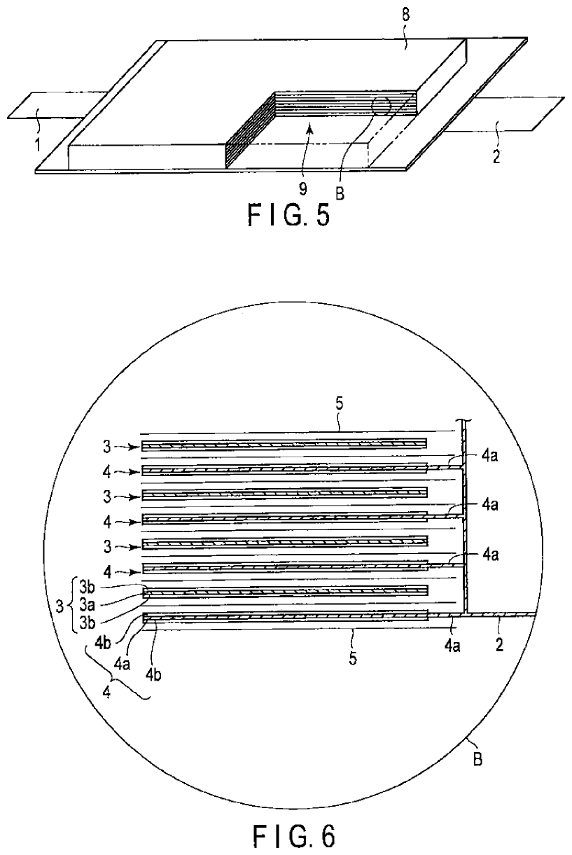

A configuration of one example of the nonaqueous electrolyte battery will be described with reference to FIG. 3 and FIG. 4. FIG. 3 shows a sectional view schematically showing the flat-type nonaqueous electrolyte battery according to the second embodiment. FIG. 4 is an enlarged sectional view showing a part enclosed by a circle indicated by “A” of FIG. 3.

As shown in FIG. 3, a flat-type wound electrode group 6 is housed in a case 7. The wound electrode group 6 has a configuration that a positive electrode 3 and a negative electrode 4 are wound in the form of a spiral with a separator 5 being disposed therebetween. The nonaqueous electrolyte is retained in the wound electrode group 6.

As shown in FIG. 4, the negative electrode 4 is disposed at an outermost periphery of the wound electrode group 6, and the positive electrode 3 and the negative electrode 4 are alternately laminated with the separator 5 being disposed therebetween in the order of separator 5, positive electrode 3, separator 5, negative electrode 4, separator 5, positive electrode 3, separator 5, in an inner periphery side of the negative electrode 4. The negative electrode 4 comprises a negative electrode current collector 4a and a negative electrode active material-containing layer 4b supported on the negative electrode current collector 4a. On the portion of the negative electrode 4 positioned at the outermost periphery, the negative electrode active material-containing layer 4b is formed only on one surface of the negative electrode current collector 4a. The positive electrode 3 comprises a positive electrode current collector 3a and a positive electrode active material-containing layer 3b supported on the positive electrode current collector 3a.

As shown in FIG. 3, a strip-shaped positive electrode terminal 1 is electrically connected to the positive electrode current collector 3a in the vicinity of an outer peripheral edge of the wound electrode group 6. A strip-shaped negative electrode terminal 2 is electrically connected to the negative electrode current collector 4a in the vicinity of the outer peripheral edge of the wound electrode group 6. Leading ends of the positive electrode terminal 1 and the negative electrode terminal 2 are led out from an identical side of the case 7 to the outside.

Hereinafter, the separator, the case, the positive electrode terminal, and the negative electrode terminal will be described.

Examples of the separator include a porous film containing polyethylene, polypropylene, cellulose, or polyvinylidene fluoride (PVdF), a synthetic resin non-woven cloth, and the like. Among these, the porous film made from polyethylene or polypropylene is preferred from the viewpoint of improvement in safety since the porous film is molten at a certain temperature and is capable of blocking a current.

As the case, a laminate film having a thickness of 0.2 mm or less or a metal container having a thickness of 0.5 mm or less may be used. The thickness of the metal container may more preferably be 0.2 mm or less. Examples of a shape of the case include a flat type, a square type, a cylindrical type, a coin type, a button type, a sheet type, a laminate type, and the like. Of course, the shape of a small battery to be mounted to a mobile electronic appliance or the like and the shape of a large battery mounted to a two- to four-wheeled vehicle may be adopted.

The laminate film is a multilayer film which is formed of a metal layer and a resin layer coating the metal layer. In order to attain a light weight, the metal layer may preferably be an aluminum foil or an aluminum alloy foil. The resin layer is provided for reinforcing the metal layer, and a polymer such as polypropylene (PP), polyethylene (PE), nylon, or polyethylene terephthalate (PET) may be used for the resin layer. The laminate film is shaped by heat-sealing.

Examples of the metal container include aluminum, an aluminum alloy, and the like. As the aluminum alloy, an alloy containing an element such as magnesium, zinc, or silicon is preferred. On the other hand, a content of a transition metal such as iron, copper, nickel, or chrome may preferably be 1 mass % or less. With the use of the above-described case, it is possible to drastically improve long-term reliability and a heat discharge property under a high temperature environment.

The metal can made from aluminum or aluminum alloy may preferably have an average crystal grain size of 50 μm or less, more preferably 30 μm or less, further preferably 5 μm or less. The strength of the metal can made from aluminum or aluminum alloy is significantly increased by setting the average crystal grain size to 50 μm or less, thereby enabling a further reduction in thickness of the can. As a result, it is possible to realize a battery which has a light weight, high output, and excellent long term reliability and is suitable for in-vehicle use.

The negative electrode terminal may be formed of a material having electrical stability and conductivity within a potential range of 0.4V (vs. Li/Li⁺) or more and 3V (vs. Li/Li⁺) or less. Specific examples of the material include an aluminum alloy containing an element such as Mg, Ti, Zn, Mn, Fe, Cu, or Si and aluminum. In order to reduce a contact resistance, a material which is the same as that of the negative electrode current collector is preferred.

The positive electrode terminal may be formed of a material having electrical stability and conductivity within a potential range of 3V (vs. Li/Li⁺) or more and 5V (vs. Li/Li⁺) or less. Specific examples of the material include an aluminum alloy containing an element such as Mg, Ti, Zn, Mn, Fe, Cu, or Si and aluminum. In order to reduce a contact resistance, a material which is the same as that of the positive electrode current collector is preferred.

The nonaqueous electrolyte battery according to the second embodiment is not limited to those having the above-described configuration shown in FIG. 3 and FIG. 4 and may have the configuration which is shown in FIG. 5 and FIG. 6. FIG. 5 is a partially broken perspective view schematically showing another flat-type nonaqueous electrolyte battery according to the second embodiment, and FIG. 6 is an enlarged view showing a part-B of FIG. 5.

As shown in FIG. 5, a laminate-type electrode group 9 is housed in a case 8 made from a laminate film. As shown in FIG. 6, the laminate-type electrode group 9 has a configuration that a positive electrode 3 and a negative electrode 4 are alternately laminated with a separator 5 being disposed therebetween. Each of the plurality of positive electrodes 3 comprises a positive electrode current collector 3a and a positive electrode active material-containing layer 3b which is supported on each of both surfaces of the positive electrode current collector 3a. Each of the plurality of negative electrodes 4 comprises a negative electrode current collector 4a and a negative electrode active material-containing layer 4b which is supported on each of both surfaces of the negative electrode current collector 4a. One side of each of the negative electrode current collector 4a of the negative electrodes 4a is projected from the positive electrode 3. The negative electrode current collectors 4a projected from the positive electrodes 3 are electrically connected to a strip-shaped negative electrode terminal 2. A leading end of the strip-shaped negative electrode terminal 2 is led out from the case 8 to the outside. Though not shown in FIG. 6, one side of each of the positive electrode current collectors 3a of the positive electrodes 3, which is positioned opposite to the side from which the negative electrode current collector 4a is projected, is projected from the negative electrode 4. The positive electrode current collectors 3a projected from the negative electrodes 4 are electrically connected to a strip-shaped positive electrode terminal 1. A leading end of the strip-shaped positive electrode terminal 1 is positioned opposite to the negative electrode terminal 2 and is led out from the case 8 to the outside.

Since the active material of the first embodiment is used for the negative electrode in the nonaqueous electrolyte battery of the second embodiment, battery swelling and a battery resistance can be suppressed. As a result, it is possible to realize a nonaqueous electrolyte battery having excellent rate performance and input-output performance.

### Third Embodiment

According to the third embodiment, a battery pack including the nonaqueous electrolyte battery of the second embodiment is provided. The number of the nonaqueous electrolyte batteries may be one or more. In the case of using the plurality of nonaqueous electrolyte batteries, the batteries may preferably be connected in series or in parallel to form a battery module.

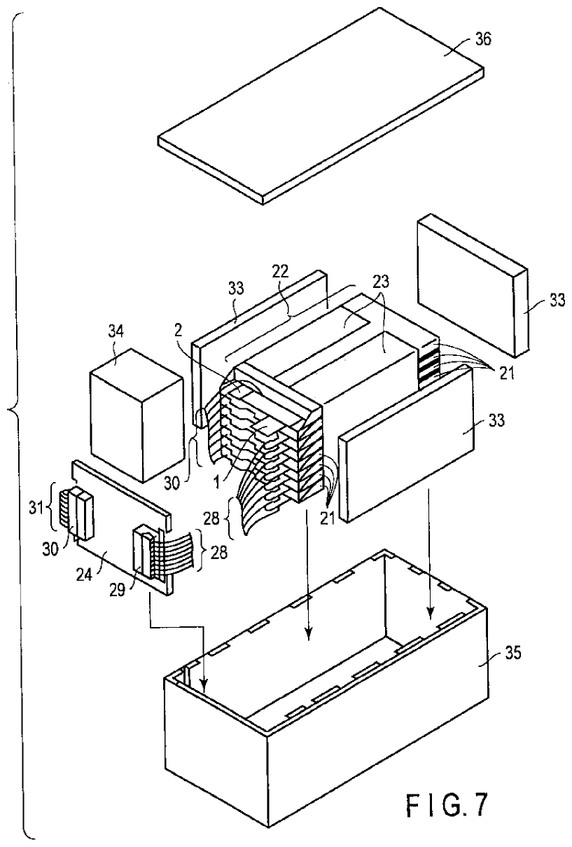

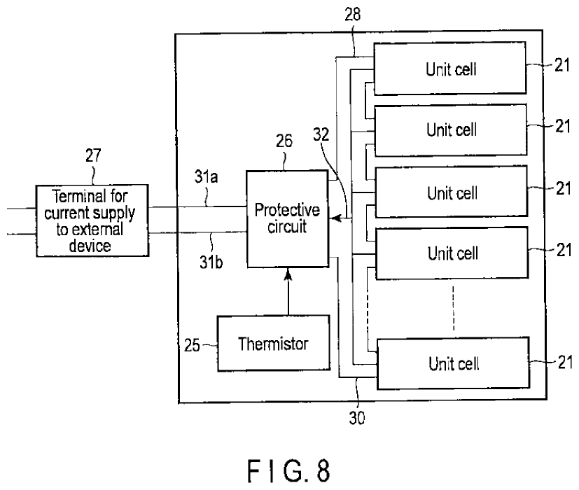

A unit cell 21 in the battery pack of FIG. 7 is formed of the flat-type nonaqueous electrolyte battery shown in FIG. 3. The plurality of unit cells 21 are laminated along a thickness direction in such a manner that the directions of projections of the positive electrode terminals 1 and the negative electrode terminals 2 are identical to each other. As shown in FIG. 8, the unit cells 21 are serially connected to form a battery module 22. The unit cells 21 are integrated into the battery module 22 by using an adhesive tape 23 as shown in FIG. 7.

A printed circuit board 24 is disposed at a lateral surface from which the positive electrode terminals 1 and the negative electrode terminals 2 are projected. As shown in FIG. 8, a thermistor 25, a protective circuit 26, and a terminal 27 for carrying a current to an external device are mounted to the printed wiring board 24.

As shown in FIG. 7 and FIG. 8, positive electrode wirings 28 of the battery module 22 are electrically connected to a positive electrode connector 29 of the protective circuit 26 of the printed wiring board 24. Negative electrode wirings 30 of the battery module 22 are electrically connected to a negative electrode connector 31 of the protective circuit 26 of the printed wiring board 24.

The thermistor 25 detects a temperature of the unit cell 21, and a detection signal is sent to the protective circuit 26. The protective circuit 26 interrupts a plus wiring 31a and a minus wiring 31b between the protective circuit and the terminal for carrying current to external device under predetermined conditions. The predetermined conditions mean a temperature detected by the thermistor which is equal to or more than a predetermined temperature and detection of an over-charge, an over-discharge, or an over-current of the unit cell 21, and the like. The detection method is performed on each of the unit cells 21 or the battery module 22. In the case where the detection is performed on each of the unit cells 21, a battery voltage may be detected, or a positive electrode potential or a negative electrode potential may be detected. In the latter case, a lithium electrode to be used as a reference electrode is inserted in each of the unit cells 21. In the case of FIG. 8, a wiring 32 for voltage detection is connected to each of the unit cells 21, and the detection signals are sent to the protective circuit 26 via the wrings 32.

In the battery module 22, on each of three surfaces other than the lateral surface from which the positive electrode terminals 1 and the negative electrode terminals 2 are projected, a protection sheet 33 made from a rubber or a resin is disposed. Between the lateral surface from which the positive electrode terminals 1 and the negative electrode terminals 2 are projected and the printed wiring board 24, a protection block 34 in the form of a block made from a rubber or a resin is disposed.

The battery module 22 is housed in a housing container 35 together with the protection sheets 33, the protection block 34, and the printed wiring board 24. More specifically, the protection sheets 33 are disposed at inner surfaces in a length direction and one of inner surfaces in a width direction of the housing container 35, and the printed wiring board 24 is disposed at the other inner surface in the width direction of the housing container 35. The battery module 22 is positioned in a space defined by the protection sheets 33 and the printed wiring board 24. A cover 36 is attached to a top surface of the housing container 35.

A heat-shrinkable tape may be used in place of the adhesive tape 23 for fixing the battery module 22. In this case, the battery module is bound by disposing the protection sheet on each of the lateral surfaces of the battery module, looping the heat-shrinkable tube around, and subjecting the heat shrinkable tube to heat shrinkage.

Though the unit cells 21 shown in FIGS. 7 and 8 are serially connected, they may be connected in parallel in order to increase a battery capacity. Of course, assembled battery packs may be connected in series or in parallel.

Further, the embodiments of the battery pack may be changed appropriately depending on a usage. As the usage of the battery pack of the third embodiment, battery packs in which the large current performance, preferably cycle performance is desired are preferred. Specific examples of the usage include a usage for a power source for a digital camera and an in-vehicle usage for a two-wheeled or four-wheeled hybrid electric vehicle, a two-wheeled or four-wheeled electric vehicle, an electric power-assisted bicycle, and the like. The in-vehicle usage is suitable.

Since the nonaqueous electrolyte battery of the second embodiment is used in the battery pack of the third embodiment, it is possible to suppress the battery swelling and battery resistance. As a result, it is possible to realize the battery pack having excellent rate performance and output performance.

Hereinafter, examples will be described. The examples described below are not limited insofar as the examples do not deviate from the scope of the embodiments.

### Example 1

### <Production of Positive Electrode>

To start with, a slurry was prepared by adding 92 mass % of a lithium manganese oxide (LiMn₂O₄) powder as a positive electrode material, 5 mass % of a carbonaceous material as a conductive agent, and 3 mass % of polyvinylidene fluoride (PVdF) to N-methylpyrrolidone (NMP), and mixing them. A positive electrode having an electrode density of 2.8 g/cm³ was prepared by coating the slurry on both surfaces of a current collector made from an aluminum foil having a thickness of 15 μm, drying, and pressing.

### <Production of Negative Electrode>

Spinel type lithium titanate (Li₄Ti₅O₁₂) was synthesized by mixing lithium carbonate with anatase type titanium oxide and then calcining at 800° C. for 10 hours. The obtained spinel type lithium titanate (Li₄Ti₅O₁₂) was subjected to ball mill pulverization in ethanol for 3 hours by using zirconia balls each having a diameter of 3 mm as a medium. The pulverized powder was impregnated into pure water to obtain a slurry, and carbon dioxide was fed to the slurry at 0.1 L/min with stirring for one hour. An ambient temperature was maintained to 0° C. An amount of the introduced carbon dioxide was equivalent to one mole per one mole of lithium carbonate in lithium titanate before a washing treatment. After that, lithium titanate was extracted by filtering, followed by a heat treatment at 500° C. for one hour, thereby synthesizing spinel type lithium titanate particles having an average particle diameter of 0.9 μm. A specific surface area of the spinel type lithium titanate particles detected by a BET method through N₂ adsorption was 10.8 m²/g.

For a measurement of an average particle diameter of the negative electrode active material, laser-diffraction-type distribution measuring device (Shimadzu SALD-300) was used. The measurement was conducted by employing a method of: adding about 0.1 g of the negative electrode active material, a surfactant, and 1 to 2 mL of distilled water in a beaker; sufficiently stirring; pouring into a stirring tank; measuring light intensity for 64 times with an interval of 2 seconds; and analyzing particle size distribution data.

Amounts of lithium carbonate and lithium hydroxide were measured by neutralization titration. More specifically, 5 g of the active material was added to 50 mL of pure water, followed by stirring for one hour, and a solid content was removed by filtering. A hydrochloric acid solution at a known concentration was added by dropping into the obtained extraction liquid until a pH of the solution reaches pH 8.4, and an amount of hydrochloric acid Z at the pH 8.4 was measured. Subsequently, the hydrochloric acid solution was added by dropping until the pH of the solution reaches pH 4.0, and an amount of the hydrochloric acid W added between pH 4.0 and pH 8.4 was measured. It is possible to consider that the hydrochloric acid amount of 2 W in the measurement corresponds to (is equivalent to) the lithium carbonate (Li₂CO₃) amount, and the [Z—W] corresponds to a total amount of lithium hydroxide (LiOH). A lithium amount X (mass %) in lithium carbonate and a lithium amount Y (mass %) in lithium hydroxide are shown in Table 2 below.

A slurry was obtained by adding N-methylpyrrolidone to 92 mass % of the spinel type lithium titanate (Li₄Ti₅O₁₂) powder, 5 mass % of a carbon material as a conductive agent, and 3 mass % of polyvinylidene fluoride (PVdF) and mixing them. The obtained slurry was coated on both surfaces of a current collector made from an aluminum foil (purity: 99.99 mass %, average crystal grain diameter: 10 μm) having a thickness of 15 μm, followed by drying and pressing, thereby obtaining a negative electrode having an electrode density of 2.2 g/cm³.

### <Production of Electrode Group>

A positive electrode, a separator formed of a porous film made from polyethylene having a thickness of 20 μm, the negative electrode, and the separator were laminated in this order and then wound in the form of a spiral, followed by heat-pressing at 90° C., thereby obtaining a flat-shaped electrode group having a width of 33 mm and a thickness of 3.0 mm. The obtained electrode group was housed in a pack made from a laminate film having a thickness of 0.1 mm, followed by vacuum drying at 80° C. for 24 hours.

### <Preparation of Liquid Nonaqueous Electrolyte>

A liquid nonaqueous electrolyte was prepared by dissolving 1 mol/L of LiPF₆ as an electrolyte into a mixture solvent obtained by mixing ethylene carbonate (EC) and diethyl carbonate (DEC) at a volume ratio of 1:2.

The liquid nonaqueous electrolyte was injected into the laminate film pack housing the electrode group, and then the pack was heat sealed, thereby obtaining a nonaqueous electrolyte secondary battery having the configuration shown in FIG. 3, a width of 35 mm, a thickness of 3.2 mm, and a height of 65 mm.

### Examples 2 to 6, Comparative Examples 1 to 3

A nonaqueous electrolyte secondary battery was produced by using the lithium titanate obtained by the above-described method and in the same manner as Example 1 except for changing the washing treatment conditions as shown in Table 1 below.

### Comparative Examples 4 and 5

A nonaqueous electrolyte secondary battery was obtained in the same manner as Example 1 except for using lithium titanate obtained by performing an acid treatment with a 1.5 mass % acetic acid solution and then drying at 120° C. for 16 hours instead of washing treatment.

### Example 7

Ramsdellite type lithium titanate was synthesized by mixing lithium carbonate and anatase type titanium oxide and performing calcination at 1050° C. for 10 hours. A washing treatment, filtering, and re-calcination were performed on the obtained ramsdellite type lithium titanate in the same manner as Example 4 to synthesize ramsdellite type lithium titanate particles having an average particle diameter of 0.9 μm and a specific surface area of 10.0 m²/g detected by the BET method through N₂ adsorption. A nonaqueous electrolyte secondary battery was produced in the same manner as Example 1 except for using the obtained ramsdellite lithium titanate particles as a negative electrode active material.

### Comparative Example 6

Ramsdellite type lithium titanate (Li₂Ti₃O₇) was synthesized by mixing lithium carbonate and anatase type titanium oxide and performing calcination at 1050° C. for 10 hours. A washing treatment, filtering, and re-calcination were performed on the obtained ramsdellite type lithium titanate in the same manner as in Comparative Example 1 to synthesize ramsdellite type lithium titanate particles having an average particle diameter of 0.9 μm and a specific surface area of 10.2 m²/g detected by the BET method through N₂ adsorption. A nonaqueous electrolyte secondary battery was produced in the same manner as Example 1 except for using the obtained ramsdellite type lithium titanate particles as a negative electrode active material.

The batteries of Examples and Comparative Examples were adjusted to SOC 50% and then left to stand for 72 hours in a constant temperature tank at 55° C. A swelling amount (B−A)/A×100[%] was determined by A standing for a battery thickness before leaving to stand and B for a battery thickness after leaving to stand. Further, a resistance increase rate D/C was determined by C standing for a battery resistance before storage and D standing for a battery resistance after storage. The results are shown in Table 2.

TABLE 1

| | | | Treatment | Treatment | |
|---|---|---|---|---|---|
| | Washing | Co₂ | temperature | time | Re- |
| | treatment | gas | (° C.) | (minute) | calcination |
| Example 1 | Performed | Introduced | 0 | 60 | Performed |
| Example 2 | Performed | Introduced | 0 | 10 | Performed |
| Example 3 | Performed | Introduced | 10 | 60 | Performed |
| Example 4 | Performed | Introduced | 20 | 60 | Performed |
| Example 5 | Performed | Introduced | 30 | 60 | Performed |
| Example 6 | Performed | Introduced | 20 | 60 | Not performed |
| Comparative | Performed | Not introduced | 20 | 60 | Performed |
| Example 1 | | | | | |
| Comparative | Not performed | — | — | — | Not performed |
| Example 2 | | | | | |
| Comparative | Not performed | — | — | — | Performed |
| Example 3 | | | | | |
| Comparative | Acetic acid | — | — | — | Not performed |
| Example 4 | treatment | | | | |
| Comparative | Acetic acid | — | — | — | Performed |
| Example 5 | treatment | | | | |
| Example 7 | Performed | Introduced | 20 | 60 | Performed |
| Comparative | Performed | Not introduced | 20 | 60 | Performed |
| Example 6 | | | | | |

TABLE 2

| | Li₂CO₃ | LiOH | X | Y | X + Y | Swelling | Resistance |
|---|---|---|---|---|---|---|---|
| | (mass %) | (mass %) | (mass %) | (mass %) | (mass %) | amount (%) | increase rate |
| Example 1 | 0.09 | 0.00 | 0.017 | 0.000 | 0.017 | <3 | 1.01 |
| Example 2 | 0.15 | 0.00 | 0.028 | 0.000 | 0.028 | <3 | 1.03 |
| Example 3 | 0.16 | 0.01 | 0.030 | 0.003 | 0.033 | <3 | 1.04 |
| Example 4 | 0.20 | 0.01 | 0.038 | 0.003 | 0.040 | <3 | 1.1 |
| Example 5 | 0.25 | 0.02 | 0.047 | 0.006 | 0.053 | 3 | 1.1 |
| Example 6 | 0.25 | 0.05 | 0.047 | 0.014 | 0.061 | 5 | 1.1 |
| Comparative | 0.37 | 0.12 | 0.069 | 0.035 | 0.104 | 20 | 1.7 |
| Example 1 | | | | | | | |
| Comparative | 0.41 | 0.69 | 0.077 | 0.200 | 0.277 | 33 | 1.8 |
| Example 2 | | | | | | | |
| Comparative | 0.40 | 0.33 | 0.075 | 0.096 | 0.171 | 30 | 1.8 |
| Example 3 | | | | | | | |
| Comparative | 0.05 | 0.00 | 0.009 | 0.000 | 0.009 | <3 | 1.7 |
| Example 4 | | | | | | | |
| Comparative | 0.06 | 0.00 | 0.011 | 0.000 | 0.011 | <3 | 1.5 |
| Example 5 | | | | | | | |
| Example 7 | 0.28 | 0.07 | 0.053 | 0.020 | 0.073 | 5 | 1.1 |
| Comparative | 0.44 | 0.16 | 0.083 | 0.046 | 0.129 | 30 | 2.0 |
| Example 6 | | | | | | | |

Referring to Table 1 and Table 2, it can be seen that as a result of comparison between Examples 1 to 6 and Comparative Examples 1 to 5 that, in the case where spinel type lithium titanate is used as the negative electrode active material, each of Examples 1 to 6 which has the lithium amount (X+Y) of 0.017 mass % or more and 0.073 mass % or less is suppressed in swelling amount and has the smaller resistance increase rate as compared to Comparative Examples 1 to 5. Each of Examples 1 to 5 which has the lithium amount (X+Y) of 0.017 mass % or more and 0.053 mass % or less has the suppressed swelling amount as compared to Example 6 which has the lithium amount (X+Y) of 0.061 mass %.

Further, when the washing treatment without introduction of carbon dioxide is performed as in Comparative Example 1, the swelling amount is slightly suppressed as compared to Comparative Examples 2 and 3 in which no washing treatment is performed, but both of the swelling amount and the resistance increase rate are poorer than Examples 1 to 6. In contrast, when the acid treatment is performed in place of the washing treatment as in Comparative Examples 4 and 5, the swelling amount is suppressed, but the resistance increase rate is little improved.

Further, as a result of comparison between Example 7 and Comparative Example 6, it is confirmed that the swelling amount and the resistance increase rate are improved by having the lithium amount (X+Y) of from 0.017 mass % to 0.073 mass %.

While certain embodiments have been described, these embodiments have been presented by way of example only, and are not intended to limit the scope of the inventions. Indeed, the novel embodiments described herein may be embodied in a variety of forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1.-15. (canceled)

16. An active material production method comprising:
synthesizing a lithium-titanium composite oxide by calcining a material containing a lithium salt and titanium oxide and
washing the lithium-titanium composite oxide with water containing carbon dioxide.

17. The active material production method according to claim 16,
wherein the lithium-titanium composite oxide subjected to the washing is subjected to a heat treatment.

18. The active material production method according to claim 17,
wherein a temperature of the heat treatment is within a range of 250° C. to 900° C.

19. The active material production method according to claim 16,
wherein a temperature of the calcination is within a range of 680° C. to 1000° C.

20. The active material production method according to claim 16,
wherein a temperature of the calcination is within a range of 900° C. to 1300° C.

21. The active material production method according to claim 16,
wherein the lithium-titanium composite oxide before the washing comprises lithium carbonate, and a mole number of the carbon dioxide relative to a mole number of the lithium carbonate is 1 or more.

22. The active material production method according to claim 16,
wherein a temperature of an atmosphere under which the washing is performed is within a range of −40° C. to 50° C.

23. The active material production method according to claim 16,
wherein the lithium-titanium composite oxide comprises at least one lithium compound selected from the group consisting of lithium carbonate and lithium hydroxide, and a lithium amount of the lithium compound is within a range of 0.017 to 0.073 mass %.

24. The active material production method according to claim 16,
wherein the lithium-titanium composite oxide has a spinel type structure.

25. The active material production method according to claim 16,
wherein the lithium-titanium composite oxide is represented by Li₄₊ₓTi₅O₁₂ (0≤x≤3).

26. The active material production method according to claim 16,
wherein the lithium-titanium composite oxide has an average particle diameter of from 10 nm to 10 μm.

27. The active material production method according to claim 16,
wherein the lithium-titanium composite oxide has a specific surface area within a range of 3 to 50 m2/g.

28. The active material production method according to claim 16,
wherein the lithium-titanium composite oxide comprises as a lithium compound lithium hydroxide, and a lithium amount of the lithium compound is within a range of 0.017 to 0.073 mass %, and
wherein the lithium-titanium composite oxide has an average particle diameter of from 10 nm to 10 μm.

29. The active material production method according to claim 16,
wherein the lithium-titanium composite oxide comprises as a lithium compound both of lithium carbonate and lithium hydroxide, and a lithium amount of the lithium compound is within a range of 0.017 to 0.073 mass %, and
wherein the lithium-titanium composite oxide has an average particle diameter of from 10 nm to 10 μm.
